(19) United States
(12) Patent Application Publication
(10) Pub. No.: US 2012/0023991 A1
(43) Pub. Date: Feb. 2, 2012

(54) ONBOARD VEHICLE COMPRESSION STORAGE SYSTEM

(75) Inventors: Edward S. Czechowski, Orchard Park, NY (US); Brad J. Wargula, Lancaster, NY (US); Miles A. Williamson, Ballston Spa, NY (US); Matthew J. Geil, Marilla, NY (US); Kenneth G. Stafford, III, Buffalo, NY (US); Jason C. Zaepfel, Niagara Falls, NY (US); Sara A. Ward, Buffalo, NY (US)

(73) Assignee: Cameron International Corporation, Houston, TX (US)

(21) Appl. No.: 12/846,712

(22) Filed: Jul. 29, 2010

(51) Int. Cl. B60H 1/32; B60C 23/10; F04B 17/06

(52) U.S. Cl. 62/241; 417/231; 60/325; 152/415

(57) ABSTRACT

A system, including a motion-driven air compressor, configured to compress air in response to motion of a vehicle, and an air storage enclosure configured to store a compressed air from the motion-driven air compressor, wherein the system is configured to deliver the compressed air to a vehicle subsystem to decrease a cost of operating the vehicle.

### BACKGROUND

This section is intended to introduce the reader to various aspects of art that may be related to various aspects of the present invention, which are described and/or claimed below. This discussion is believed to be helpful in providing the reader with background information to facilitate a better understanding of the various aspects of the present invention. Accordingly, it should be understood that these statements are to be read in this light, and not as admissions of prior art.

A variety of natural resources are used to power modern technology. Unfortunately, certain natural resources, such as oil and gas, are limited and difficult to reach. Renewable resources, such as solar, wind, and hydropower, are particularly advantageous due to their abundance. However, modern technology is far from efficient in using various resources, and often creates significant waste energy. This waste energy is largely untapped, and thus represents a significant energy resource in the face of increasing energy demand and decreasing energy supply in modern civilization.

### BRIEF DESCRIPTION OF THE DRAWINGS

Various features, aspects, and advantages of the present invention will become better understood when the following detailed description is read with reference to the accompanying figures in which like characters represent like parts throughout the figures, wherein:

FIG. 1 is a schematic of an embodiment of a vehicle using a motion-driven air compressor, air storage enclosure, and controller that delivers air to vehicle subsystems;

FIG. 2 is a flow chart illustrates a process according to one embodiment of the motion-driven air compressor;

FIG. 3 is a schematic of an embodiment of a motion driven air compressor and its interaction with a compressed air storage enclosure, vehicle subsystem controller, and vehicle subsystems; and

FIG. 4 is a block diagram of the various vehicle subsystems and external systems that may utilize compressed air created by a motion-driven air compressor.

### DETAILED DESCRIPTION OF SPECIFIC EMBODIMENTS

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Moreover, the use of “top,” “bottom,” “above,” “below,” and variations of these terms is made for convenience, but does not require any particular orientation of the components.

The present disclosure is directed to an onboard compression system that uses a vehicles vertical motion during travel to compress air. When a vehicle is driven, it will be subjected to vertical motion due to the unevenness of the ground over which it travels. The shocks, struts, and tires normally absorb the vehicle's vertical motion. This results in wasted energy that could be utilized to decrease the vehicle's operating cost. Advantageously, the vehicles motion could be used to compress air. The compressed air may then be used to power various subsystems, reducing the operating cost of the vehicle. For example, the on-board compressed air may enable use of pneumatic driven equipment rather than electronic-driven equipment to decrease fuel costs, reduce wear on parts, and receive credits, etc. Fuel costs should be understood to mean fuel consumption, fuel price, or both fuel consumption and fuel price. The on-board compressed air may decrease the vehicle's operating costs by powering various onboard vehicle subsystems, assisting in the powering of various onboard vehicle subsystems, or obtaining a reward by delivering the compressed air to an external system. Examples of these subsystems may include: air conditioning systems, air inflation systems, engine support systems, access systems, interior comfort systems, disability systems, pneumatic systems, fluid systems, electrical systems, large vehicle systems, external discharge systems, and driver assist systems.

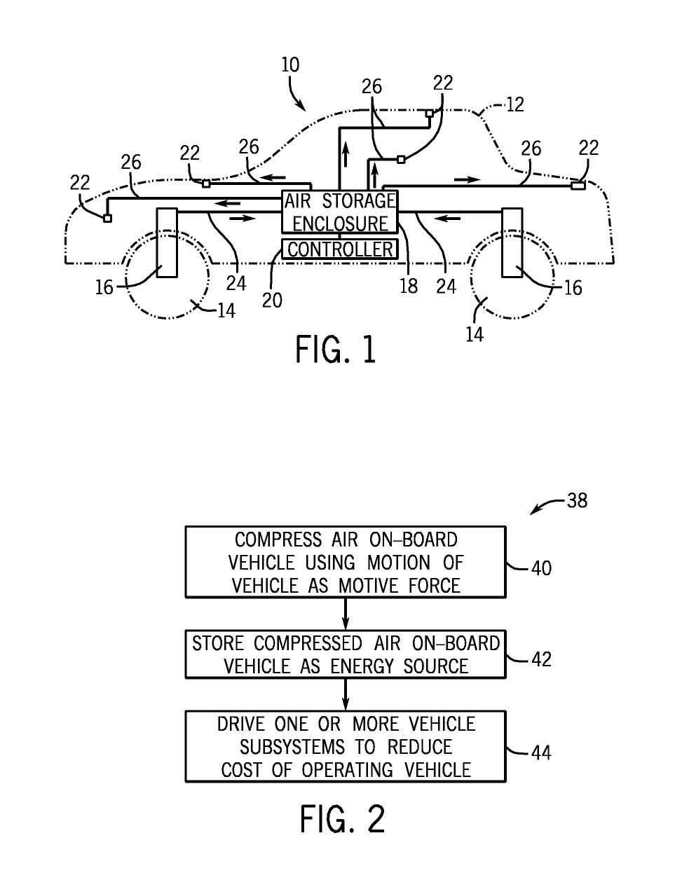

FIG. 1 is a schematic of an embodiment of a vehicle 10 that includes a motion driven compression system for powering various subsystems. The vehicle 10 includes a body 12, tires 14, a motion-driven air compressor 16, an air storage enclosure 18, a controller 20, and vehicle subsystems 22. When the vehicle 10 is driven, it will naturally experience vertical oscillations due to the unevenness of the surface on which it travels. This constantly changing vertical motion is typically absorbed by the shocks, struts, and tires creating a smoother ride. In the present embodiment, the motion-driven air compressor 16 uses the vertical motion of the vehicle 10 to compress and transport air. The compressed air is moved through air lines 24 into the air storage enclosure 18. A controller 20 connected to the air storage enclosure 18 controls when compressed air is released from the air storage enclosure 18 to operate various vehicle subsystems 22. Upon receiving a signal from the vehicle's onboard electronics or the respective vehicle subsystem 22, the controller 20 releases compressed air through air lines 26, thus providing a source of power to the vehicle's subsystems 22.

While in the present embodiment a car is illustrated as the vehicle 10, a car is merely exemplary and is not intended to limit the invention in any manner. In fact, the motion-driven air compressor 16 may be used in trucks, recreational vehicles (RV), vans, sport utility vehicles (SUV), tractors, motorcycles, watercraft, aircraft, locomotives, and other such vehicles. While two motion driven air compressors 16 are illustrated, a vehicle may have 1, 2, 3, 4, 5 or more motion driven air compressors 16. The size, number, and configuration of the motion-driven air compressors 16 is dependent upon compressed air requirements (e.g., high pressure, low pressure, number of subsystems using compressed air, amount of compressed air needed by a particular vehicle subsystem, etc.). In addition, while only one air storage enclosure 18 is illustrated, the vehicle 10 may include multiple air storage enclosures 18. Each of the air storage enclosures 18 may be coupled to a respective motion driven air compressor 18 or multiple motion driven air compressors 18 may feed multiple air storage enclosures 18. Furthermore, an air storage enclosure(s) 18 may be specifically dedicated to provide compressed air to one or more vehicle subsystems 22. In some embodiments, the air storage enclosures 18 may be defined by cavities within the framework of the vehicle 10 to store the compressed air, thereby saving space in the vehicle 10. For example, each tubular frame member of the vehicle 10 may be sealed to define an air storage enclosure 18. Thus, depending on the amount of framework, the vehicle 10 may include 1 to 100 independent or linked air storage enclosures 18 integrated into the vehicle 10. Similarly, the present embodiment is not limited to a single controller 20 but multiple controllers 20 may exist for controlling the release of compressed air from a single air storage enclosure 18 or multiple air storage enclosures 18.

FIG. 2 is a flow chart that illustrates a process 38 according to one embodiment of the on-board motion-driven air compression system. The process 38 begins with compressing air onboard the vehicle using the vehicle's motion as the motive force (block 40). For instance, the compressed air may be generated by use of a piston cylinder device. The process 38 proceeds by storing the compressed air onboard as the energy source for the vehicle subsystems 42. The compressed air may be stored in variety of locations including, the framework of the vehicle or within one or more storage tanks. The process 38 also includes driving one or more vehicle subsystems to reduce the cost of operating the vehicle 44. Examples of possible subsystems may include: air conditioning systems, air inflation systems, engine support systems, access systems, interior comfort systems, disability systems, pneumatic systems, fluid systems, electrical systems, large vehicle systems, external discharge systems, and driver assist systems.

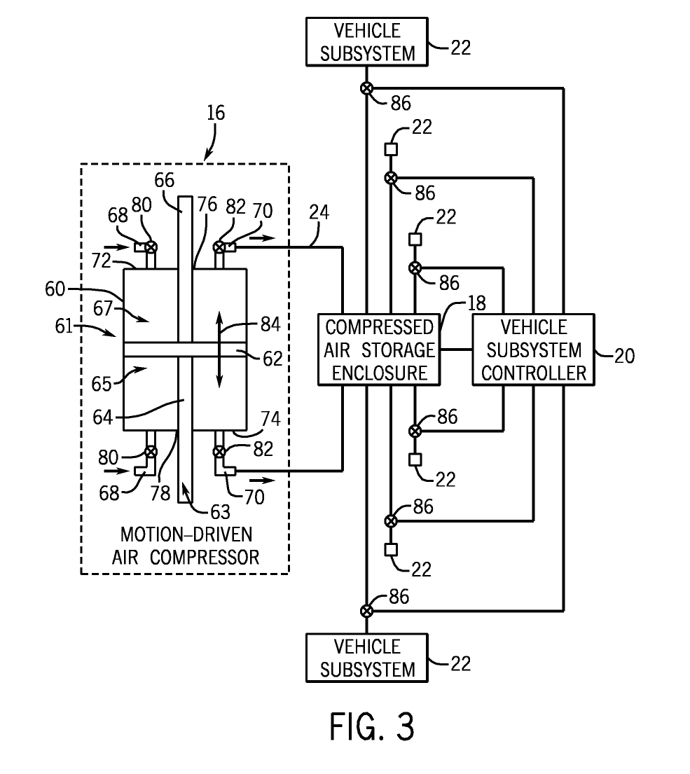

FIG. 3 is a schematic of an embodiment of a motion driven air compressor 16 and its interaction with a compressed air storage enclosure 18, vehicle subsystem controller 20, and vehicle subsystems 22 of an on-board motion driven compression system. As discussed above, the motion driven air compressor 16 uses the changing vertical motion of the vehicle 10 to compress air. The compressed air is then collected in the air storage enclosure 18. As the vehicle subsystem controller 20 receives signals from the vehicle subsystems 22, the controller 20 may then cause the air storage enclosure 18 to flow the compressed air, stop the flow of compressed air, or maintain the flow of compressed air to one or more vehicle subsystems 22.

The motion driven air compressor 16 includes: a cylinder 60, a piston 62, a shaft 63 (e.g., lower shaft 64 and upper shaft 66), intake nozzles 68, and outflow nozzles 70. The cylinder 60 defines a chamber 61 divided by the piston 62 into a lower chamber 65 and an upper chamber 67. The cylinder 60 further defines a top surface 72 and a bottom surface 74. The top and bottom surfaces 72 and 74 further define apertures 76 and 78 respectively. The apertures 76 and 78 enable axial movement of the respective upper and lower shafts 64 and 66 within the cylinder 60. Some embodiments may include seals (e.g., o-rings) between the upper and lower shafts 64 and 66, and the apertures 76 and 78. The seals assist in blocking air leakage during compression. Furthermore, air intake and outflow nozzles 68 and 70 include one-way valves 80 and 82 (e.g., check valves). These one-way valves 80 and 82 only allow air to travel in a single direction. Thus, the intake nozzles 68 only allow air to flow into the cylinder 60, while the outflow nozzles 70 only allow air, above a certain pressure, to flow out of the cylinder 60. In the present embodiment, the compressor 16 includes two intake and outflow nozzles 68 and 70. Other embodiments may include more or less intake and outflow nozzles 68 and 70 per cylinder.

In the present embodiment, the motion driven air compressor 16 is designed for dual action, whereby air compression occurs in both the upward and downward strokes in the lower and upper chambers 65 and 67. In other embodiments, the air compression may only occur in a single direction, in either the lower or the upper chamber 65 or 67. As the vehicle body moves up and down, the upper and lower shafts 64 and 66 move within the cylinder 60 in the direction of arrows 84. For instance, the lower shaft 64 drives the piston 62 upward in the direction 84 as an upward force is imparted on the vehicle 10. The upward force may result from a bump in the road, which causes upward movement of the tire 14 relative to the body 12 of the vehicle 10. As the piston 62 moves upward (i.e., the upstroke), the piston 62 compresses air in the upper chamber 67 while drawing in additional air in the lower chamber 65. As discussed previously, the intake nozzles 68 include one-way valves 80 to enable only intake airflow, thus the only exit for the air is through the outflow nozzles 70. As mentioned above, the outflow nozzles 70 include a one-way valves 82 (e.g., check valves) that open at certain pressures. Upon reaching the proper pressure, the one-way valves 82 open to route the compressed air to the air storage enclosure 18. During the upstroke, the valve 80 is closed and the valve 82 eventually opens in the upper chamber 67, while the valve 80 is open and the valve 82 is closed in the lower chamber 65. More specifically, in the upper chamber 67, the valve 82 opens as the piston 62 approaches top dead center (e.g., the surface 72) of the upper chamber 67. As the piston 62 changes directions the valves 80 and 82 also reverse their states.

As the piston 62 begins the downward stroke, the valve 80 opens and the valve 82 closes in the upper chamber 67, thereby allowing the piston 62 to draw air into the upper chamber 67. Simultaneously, the valve 80 closes and the valve 82 eventually opens in the lower chamber 65, as the piston 62 gradually compresses air in the lower chamber 65 and then expels the compressed air through the valve 82 at a sufficiently high pressure. The cycle repeats in this manner to provide alternating compression and air intake in the opposite chambers 65 and 67. Each reversal of the piston 62 causes the chambers 65 and 67 to change functions from air intake to air compression, and vice versa. Advantageously, each disturbance in the road may cause both an upward stroke and a downward stroke of the piston 62 providing air compression in both chambers 65 and 67.

The illustrated compressor 16 is a single stage duel-acting compressor. In some embodiments, the on-board motion driven compression system may include a multi-stage compression system driven by vehicle motion. For example, the system may include a series of motion-driven compressors 16 to sequentially compress air in stages, each stage compressing the air to a higher pressure. The multi-stage compression system may be capable of providing higher pressures, while using all available motion energy for air compression.

The compressed air leaving the outflow nozzles 70 travels through the air lines 24 into the air storage enclosure 18. As previously discussed, the vehicle subsystem controller 20 may receive signals from the vehicle subsystems 22 or other onboard electronics. The controller 20 may respond to a signal from a vehicle subsystem 22 to open or close an appropriate valve 86. When the valve 86 opens, compressed air is released to do work for a vehicle subsystem 22. After completion, the vehicle subsystem 22 or other onboard electronics sends a signal to the controller 20 indicating the work is complete. The controller 20 then signals the valve 86 to close, cutting off the compressed air from the compressed air storage enclosure 18.

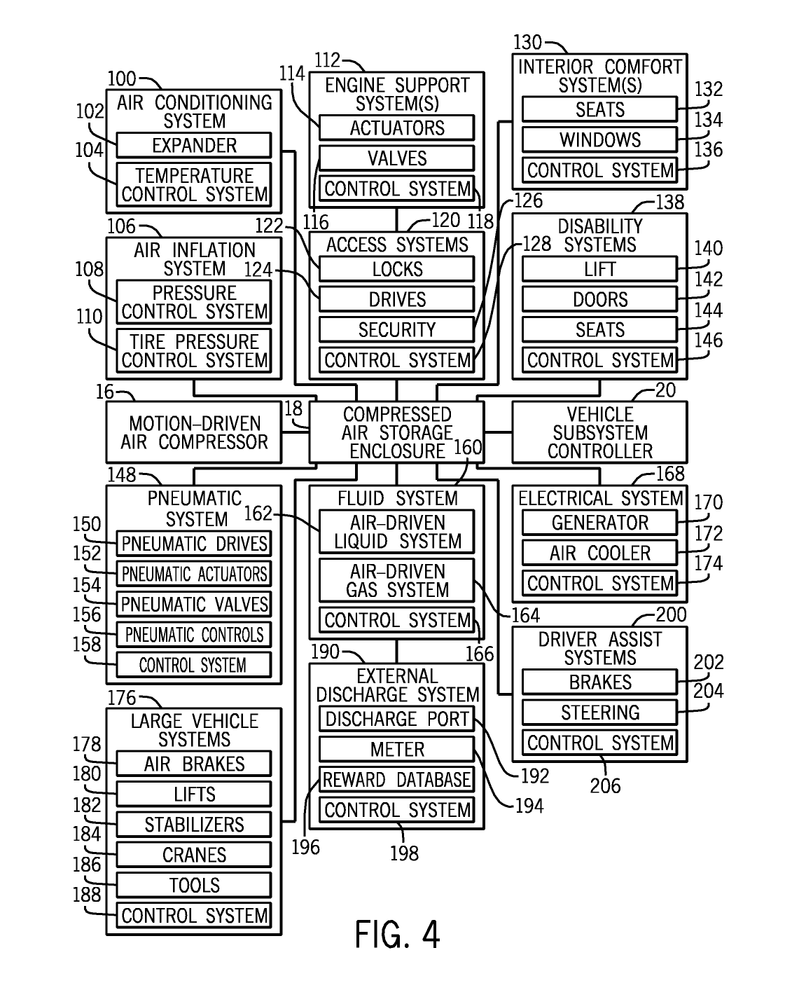

FIG. 4 is a block diagram of the various vehicle subsystems 22 that may utilize air pressure created by a motion-driven air compressor 16 to reduce the vehicle's operating costs. Vehicle subsystems 22 may include: air conditioning systems 100, air inflation systems 106, engine support systems 112, access systems 120, interior comfort systems 130, disability systems 138, pneumatic systems 148, fluid systems 160, electrical systems 168, large vehicle systems 176, external discharge systems 190, and driver assist systems 200.

Air condition system 100 could use the compressed air in an expander 102 or in a temperature control system 104 among other possibilities. The expander 102 would take advantage of the cooling effect that occurs as compressed air expands from high pressure to low pressure. This cooling effect created by the expansion of the compressed air in the expander 102 could be used to supplement an A/C system or even completely replace the A/C system. The use of expander 102 to remove all or part of the workload of an A/C would be particularly advantageous due to the operating costs associated with using an A/C unit. Temperature control system 104 could take advantage of compressed air to change the temperature in a vehicle by moving air past heaters or coolers and into the cabin without the use of fans. The temperature control system 104 may further include an air conditioning control system capable of controlling the expansion of the compressed air for cooling to decrease an engine load on the vehicle. This would therefore require less electricity to be generated by the alternator and in turn a smaller workload for the engine saving fuel and possibly part replacement. Furthermore, compressed air could quickly move large amounts of air past heaters or coolers, optimizing the interior comfort of the vehicle faster than by using fans.

An air inflation system 106 could use the compressed air in a pressure control system 108 or in a tire pressure control system 110. The pressure control system 108 could be used to rapidly inflate objects such as air bags to a specific pressure upon vehicle collision. The tire pressure control system 110 could take advantage of onboard generation of compressed air, by adjusting the tire pressure. Tires that are maintained at the proper pressure save on fuel costs and prevent excessive tire tread wear.

The engine support system 112 could use the compressed air to operate various actuators 114 and valves 116. The air driven actuators 114 and valves 116 reduce the electrical load on the battery, and thereby reducing the load on the engine to improve fuel economy. The actuators 114 and valves 116 may include fuel injectors, lubricant actuators/valves, coolant actuators/valves, and so forth. Finally, the control system 118 controls the operation and actuation of the various actuators 114 and valves 116.

The access systems 120 could use the compressed air to power locks 122, drives 124, and security systems 126. In place of electrical power used for power locks 122, compressed air could be used to lock various compartments on a vehicle (e.g., door locks, trunk locks, hood locks, sunroof locks, convertible top locks, storage compartment locks, wheel locks, steering locks, etc.). These systems would take advantage of the force generated by compressed air to move the locking mechanism back and forth. Finally, a control system 128 may be included for controlling the operation of the various locks 122, drives 124, and security systems 126.

Interior comfort systems 130 could use the compressed air to power seats 132, windows 134, and sunroofs. Rather than use an electric motor to move the seat through various seat configurations, an air motor could be used to power the seat. Compressed air could also be used to inflate seats, parts of seats (e.g., lower lumbar support, armrest, headrest etc.) or other parts of the vehicle, such as the steering wheel. Compressed air could also be used to open and close windows 134 and sunroofs, rather than use electric power or manual force. Finally, the control system 136 may be included to control the seats 132, windows 134, and other comfort systems, etc.

Disability systems 138 could be used to power lifts 140, doors 142, and seats 144. A hydraulic lift is often employed to lift disabled individuals into vehicles. Instead, the pneumatic lift 140 is driven by the onboard motion generated compressed air. Furthermore, the onboard motion generated compressed air is used to power the doors 142 and seats 144, e.g., to assist a disabled person the doors 142 and seats 144 could be powered by compressed air allowing for an automatic opening of the doors 142 and ease in rotating or changing the configuration of the seats 144. Finally, a control system 146 may be included for operating the lift 140, door 142, and seats 144.

The pneumatic system 148 could use the compressed air to power pneumatic drives 150, pneumatic actuators 152, pneumatic valves 154, and pneumatic controls 156. These devices assist in operating the devices mentioned above (e.g., air driven windows, doors, trunks, seats, sunroofs, convertible tops, hoods, windshield wipers, steering, brakes, storage compartments/doors, vents, lifts, etc.). Finally, a pneumatic control system 158 may control the pneumatic drives 150, pneumatic actuators 152, pneumatic valves 154, and pneumatic controls 156.

The fluid system 160 could use the compressed air to power an air-driven liquid system 162, and an air-driven gas system 164. Some of the potential liquid systems that could take advantage of compressed air could include fuel pumps, hydraulic fluid pumps, oil pumps, water pumps, transmission fluid pumps, and power steering fluid pumps, windshield wiper fluid pumps, among others. In addition to, pumps, the air-driven liquid systems 162 may include other pneumatic drives. Some of the air driven gas systems 164 could include operating an air pump that drives fresh air into the cabin, a pump that circulates cabin air, etc. Finally, a fluid control system 166 may be included for operating the air-driven liquid systems 162 and the air-driven gas systems 164, and wherein the fluid control system 166 controls the flow of the fluid or gas as well as their pressures.

The electrical system 168 could use the compressed air to power a generator 170, and an air-powered cooler 172. In one embodiment, the compressed air could be used to rotate a shaft within a generator 170 creating electricity. The compressed air could also be used to power a cooler by providing the power to compress the coolant in a refrigerant cycle. In addition, the compressed air could be used to cool the various electronics onboard (e.g., Page of expander, fans, may blow compressed air directly over electronics, etc.). Finally, a control system 174 may be included for operating the generator 170 and air cooler 172.

Large vehicle systems 176 could use the compressed air to power air brakes 178, lifts 180, stabilizers 182, cranes 184, tools 186, and control systems 188. Thus, rather than relying on electrical drives or electrically driven compressors, the large vehicle systems 176 employ compressed air from the motion driven air compressor 16. The air brakes 178 may replace manual brakes or air brakes relying on electrically driven air compressors. The air lifts 180 may replace hydraulic lifts or electrically driven lifts or the compressed air may be used to drive hydraulics. In this way, the motion driven air compressor 16 could supply the air pressure to power the lifts 180. Other lifts 180 that could take advantage of the compressed air include lifts on trash trucks/dump trucks that raise and lower the dump portion, the front hooks that lift trash bins, or the compressors for compressing the trash onboard a trash truck. Furthermore, the air stabilizers 182 may replace hydraulic or electric driven stabilizers, or the compressed air may be used to drive the hydraulics. Likewise, air cranes 184 may replace hydraulic or electric drive cranes, or the compressed air may be used to drive hydraulics. The compressed air could also be used to power tools (e.g. power hammers, jackhammers, drills, etc.) carried on the vehicle. In some embodiments, the compressed air may be stored in removable tanks, which can be carried off the vehicle for use on a worksite. Finally, a control system 188 may be included for controlling the air brakes 178, lifts 180, stabilizers 182, cranes 184, and tools 186.

In some embodiments, the onboard compressed air could be used to power onboard systems and discharge the remaining compressed air to an external system 190. In still further embodiments, all of the compressed air generated while driving could be discharged to an external system 190. One of the ways to take advantage of the onboard compressed air generation is to release it through a discharge port on the vehicle. The discharge port could be a quick disconnect port for attachment to an air hose, external air station, or air supply nozzle. For example, the discharge port may allow discharge of the air through a hose to pump up bike tires, four wheeler tires, air mattresses, inflatable toys, inflatable playhouses, and so forth. In still other embodiments, the compressed air could be discharged to a commercial tank collecting from multiple vehicles. These discharges could occur at parking meters, parking garages, gas stations, parking lots (e.g., mall, grocery store, restaurants, shopping centers etc.), on ferries, camping sites, toll booths, etc. During discharge, a meter 194 may register how much air is being discharged by the vehicle. After discharge, the meter 194 could communicate with a rewards system to indicate how much monetary reward, cash back, free item (e.g., coffee, donut etc.), price reduction, rewards points, credit for future purchases, etc. that the particular discharge is worth. In still other embodiments, the reward system might communicate with a larger system that could track a vehicle or an individual in order accumulate rewards from discharges at multiple locations, and store the rewards in a database 196.

In addition, the continuous discharge of compressed air by multiple vehicles to an external system could be used to perform a variety of tasks most notably to power air-driven electrical generators, or motors that would provide power for parking garages, gas stations, office buildings etc. Finally, a control system 198 may be included to control the air-driven electrical generators, motors, and control delivery of the compressed air from the vehicle to the external system 190.

In still other embodiments, the onboard motion generated compressed air could be used to assist in driver systems 200. One of these systems that could take advantage of the compressed air could be the braking system 202. This could take the form of air brakes as discussed above with respect to large vehicle systems or it could be used to make the braking easier for the driver, by providing additional force once it senses braking. Power steering 204 could be another system that takes advantage of the compressed air. Rather than use a fluid based power steering system, an air driven power steering system could be used or compressed air could possible supplement the fluid based power steering system. Finally, the control system 198 for the braking system 202, power steering systems 204, etc. could take advantage of the compressed air by operating the drives, actuators, valves, controls, etc.

All of these systems and devices could take advantage of the compressed air created by the vertical oscillations a vehicle experiences while traveling. While the savings created by use of these systems may initially appear small, in the long term and in aggregate use, these systems would generate a significant amount of savings for the individual and the environment by helping to conserve oil, coal, and other nonrenewable energy resources.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

1. A system, comprising:
a motion-driven air compressor configured to compress air in response to motion of a vehicle; and
an air storage enclosure configured to store a compressed air from the motion-driven air compressor, wherein the system is configured to deliver the compressed air to a vehicle subsystem to decrease a cost of operating the vehicle.

2. The system of claim 1, wherein the system is configured to deliver the compressed air to an air inflation system of the vehicle subsystem.

3. The system of claim 2, wherein the system is configured to deliver the compressed air to a tire pressure control system of the air inflation system, wherein the tire pressure control system is configured to adjust a tire pressure with the compressed air to decrease a fuel consumption of the vehicle.

4. The system of claim 1, wherein the system is configured to deliver the compressed air to an air conditioning system of the vehicle subsystem, wherein the air conditioning system is configured to use the compressed air to decrease an engine load on the vehicle.

5. The system of claim 4, wherein the air conditioning system is configured to expand the compressed air to provide a cooled expanded air.

6. The system of claim 1, wherein the system is configured to deliver the compressed air to a pneumatic lock of the vehicle subsystem.

7. The system of claim 1, wherein the system is configured to deliver the compressed air to a fluid system to drive a fluid in the vehicle subsystem.

8. The system of claim 1, wherein the system is configured to deliver the compressed air to an electrical system in the vehicle subsystem.

9. The system of claim 1, wherein the system is configured to deliver the compressed air to a pneumatic drive in the vehicle subsystem.

10. The system of claim 1, wherein the system is configured to deliver the compressed air to an external system outside the vehicle.

11. The system of claim 10, wherein the system is configured to deliver the compressed air to the external system to receive a reward.

12. The system of claim 1, wherein the air storage enclosure comprises integral cavities within a framework of the vehicle.

13. A system, comprising:
a motion-driven air compressor configured to compress air in response to motion of a vehicle; and
a vehicle subsystem configured to receive a compressed air from the motion-driven air compressor to decrease a cost of operating the vehicle.

14. The system of claim 13, wherein the vehicle subsystem comprises a tire pressure control system configured to adjust a tire pressure with the compressed air to decrease a fuel consumption of the vehicle.

15. The system of claim 13, wherein the vehicle subsystem comprises an air conditioning system configured to use the compressed air to decrease an engine load on the vehicle.

16. The system of claim 13, wherein the vehicle subsystem comprises an air discharge system configured to deliver the compressed air to an external system outside the vehicle to receive a reward.

17. The system of claim 13, wherein the vehicle subsystem comprises a pneumatic lock, a pneumatic drive, or a combination thereof.

18. The system of claim 13, wherein the vehicle subsystem comprises a fluid system to drive a liquid or a gas in the vehicle.

19. The system of claim 13, wherein the vehicle subsystem comprises an electrical system, wherein the electrical system comprises an electrical generator driven by the compressed air or electronics cooled by the compressed air.

20. A system, comprising:
a vehicle subsystem controller configured to control usage of a compressed air from a motion-driven air compressor by a vehicle subsystem to decrease a cost of operating a vehicle.

21. The system of claim 20, wherein the vehicle subsystem controller comprises a tire pressure control system configured to adjust a tire pressure with the compressed air to decrease a fuel consumption of the vehicle.

22. The system of claim 20, wherein the vehicle subsystem controller comprises an air conditioning control system configured to control expansion of the compressed air for cooling to decrease an engine load on the vehicle.

23. The system of claim 20, wherein the vehicle subsystem controller comprises an air discharge control system configured to control delivery of the compressed air to an external system outside the vehicle in exchange for a reward.

24. The system of claim 20, wherein the vehicle subsystem controller comprises a fluid control system configured to control a fluid flow or a fluid pressure in a fluid system in the vehicle.

25. A system, comprising:
a motion-driven air compressor configured to compress air in response to motion of a vehicle;
a vehicle subsystem comprising a vehicle tire or a vehicle air conditioning system; and
a vehicle subsystem controller configured to control delivery of the compressed air from the motion-driven air compressor to the vehicle subsystem to decrease a cost of operating the vehicle.
